(19) United States
(12) Patent Application Publication
(10) Pub. No.: US 2022/0062764 A1
(43) Pub. Date: Mar. 3, 2022

(54) GAME CONTROL METHOD, DOCKING STATION AND GAME CONTROL SYSTEM

(71) Applicant: SHENZHEN PALAMOUNT TECHNOLOGY CO., LTD, SHENZHEN CITY (CN)

(72) Inventor: JIE LI, FUYANG CITY (CN)

(21) Appl. No.: 17/095,920

(22) Filed: Nov. 12, 2020

(30) Foreign Application Priority Data
Sep. 3, 2020 (CN) 202010917988.3
Sep. 3, 2020 (CN) 202021924753.9

(51) Int. Cl. A63F 13/537; G06F 3/16; G06F 3/14; G06F 3/041; H04R 1/04; H04N 7/01; G06F 3/02; A63F 13/214

(52) U.S. Cl. CPC A63F 13/537; G06F 3/162; G06F 3/14; G06F 3/041; H04R 2499/15; H04N 7/01; G06F 3/02; A63F 13/214; H04R 1/04

(57) ABSTRACT

A game control method, a docking station and a game control system are provided to solve that mobile terminals such as mobile phones cannot be connected to a display device and an input device at the same time, causing that mobile game interface is small and the control is inconvenient. The method includes steps: receiving manipulation information from an input device via a first port; receiving video information from a mobile device via a second port; obtaining touch position information of a game interface corresponding to the manipulation information according to a mapping relationship, then transmitting it to the mobile device from the second port; and transmitting the video information to the display device from a third port. The docking station includes a computer program that performs the above steps. The system includes the docking station, and mobile device, display device and input device connected through the docking station.

### FIELD OF THE DISCLOSURE

The present disclosure relates to the field of game control, in particular to a game control method, a docking station and a game control system. The game control method and the game control system use the docking station as a medium for controlling the game of a mobile device. The docking station can be used as media for controlling mobile device games through the input device and displaying game content through the display device.

### BACKGROUND OF THE DISCLOSURE

Mobile games refer to games that can be played on mobile devices such as mobile phones and tablets. With the increase in computing power, image processing capabilities, and storage capacity of mobile devices such as smart phones and tablet computers, mobile games have been developed significantly.

Mobile games have the advantage that they can be played anytime, anywhere without geographical restrictions. However, there are problems such as small display screen, inability to use keyboard and mouse to control, and inconvenient control.

Connecting the mobile device to an external display device can solve the problem of small display screen of the mobile device. As shown in FIG. 1, through the game simulator, an external keyboard and mouse can be used to control the game. However, because mobile devices such as smart phones and tablet computers have only one port, it is impossible to connect external display devices and game simulators at the same time, which makes it impossible to solve the problems of small display screen and inconvenient control at the same time.

### SUMMARY OF THE DISCLOSURE

The primary purpose of the present disclosure is to provide a game control method, a docking station and a game control system to solve the above-mentioned defects in the prior art.

In order to achieve the above objectives, the technical solutions adopted by the present disclosure are as follows.

A game control method is provided, comprising the following steps: receiving manipulation information from an input device via a first port; receiving video information from a mobile device via a second port; obtaining touch position information of a game interface corresponding to the manipulation information according to a mapping relationship, and transmitting the touch position information of the game interface from the second port to the mobile device; and transmitting the video information from a third port to a display device.

In a preferred embodiment, the game control method further comprises: receiving audio information from the mobile device from the second port; and transmitting the audio information from the third port to the display device; wherein, the display device includes a speaker.

In a preferred embodiment, the game control method further comprises: receiving a power via a fourth port; and providing the power from the second port to the mobile device.

In a preferred embodiment, the game control method further comprises: performing a format conversion on the video information before the video information is transmitted from the third port to the display device.

In a preferred embodiment, the manipulation information comprises a plurality of bytes, wherein one of the plurality of bytes is configured to characterize a key value of a function key, and the other of the plurality of bytes are configured to characterize key values of letter keys, arrow keys and/or number keys.

A docking station is provided, comprising: a first port configured to connect an input device; a second port configured to connect to a mobile device; a third port configured to connect to a display device; a memory; a processor; and a computer program stored in the memory and capable of running on the processor, and wherein when the processor runs the computer program, the docking station executes the game control method as mentioned above.

In a preferred embodiment, the second port comprises a power terminal and a data terminal configured to transmit information bidirectionally.

In a preferred embodiment, the second port is a USB TYPE-C port.

In a preferred embodiment, the docking station further comprises a format converter connected between the third port and the second port.

In a preferred embodiment, the docking station further comprises: a fourth port configured to be connected to power supply equipment; and a power converter connected between the fourth port and the second port.

A game control system is provided, comprising: a mobile device capable of running games; an input devices configured to control games; a display device configured to display game content; and a docking station respectively connected to the mobile device, the input device and the display device, and wherein the docking station is the docking station as mentioned above.

In a preferred embodiment, the input device comprises a keyboard and the mobile device comprises a smart phone, a tablet computer, or a handheld game console.

Compared with the prior art, the present disclosure has at least the following beneficial effects.

The present disclosure uses a special docking station as a medium to connect the input device, the mobile device and the display device, so that when the external display device is used to display the game, the external input device can be used to control the mobile device game, thereby simultaneously solving the problem of small display interface of the mobile game and the problem of inconvenience in handling.

### BRIEF DESCRIPTION OF THE DRAWINGS

FIG. 1 is a schematic diagram of controlling a mobile device game through an external keyboard and mouse in the prior art.

FIG. 2 is a schematic diagram of an application of the game control method.

FIG. 3 is a flowchart of the game control method.

FIG. 4 is a schematic diagram of the structure of manipulation information.

FIG. 5 is a schematic diagram of mapping a game interface of a mobile device to a display device.

FIG. 6 is a circuit block diagram of the docking station.

FIG. 7 is a block diagram of the game control system.

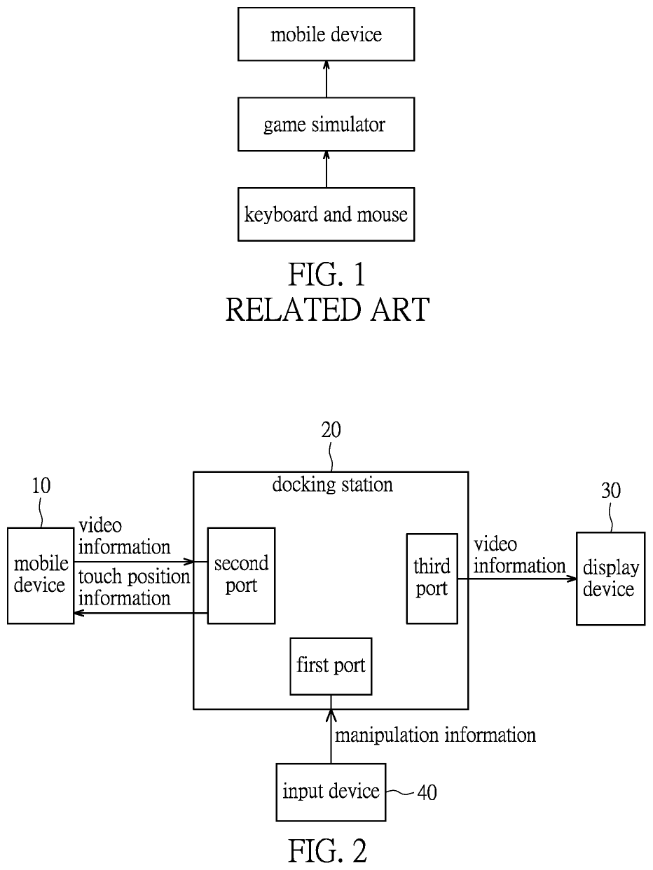

Reference numeral: 10. mobile device; 20. docking station; 30. display device; 40. input device; 21. second port; 22. memory; 23. processor; 24. first port; 25. format converter; 26. third port; 27. power converter; 28. fourth port.

### DETAILED DESCRIPTION OF THE EXEMPLARY EMBODIMENTS

The present disclosure aims to solve the problem that mobile terminals such as mobile phones cannot connect external display devices and input devices at the same time, as well as the problems of small interface of the mobile game and inconvenient operation caused thereby. The present disclosure will be further described below in conjunction with the drawings and embodiments.

### First Embodiment: Game Control Method

The game control method is executed by a docking station 20. Its application is shown in FIG. 2, namely: a mobile device 10 is connected to the docking station 20, and the docking station 20 is also connected to a display device 30 and an input device 40 respectively. The mobile device 10 transmits video information (game screen) to the display device 30 through the docking station 20 to map and display the video information on the display device 30. The input device 40 controls the game of the mobile device 10 through the docking station 20, and the docking station 20 can also supply power to the mobile device 10. The mobile device 10 here can be any mobile device 10 capable of running games, including but not limited to smart phones, tablet computers, handheld game consoles, etc. The input device 40 here includes a keyboard, preferably a mouse.

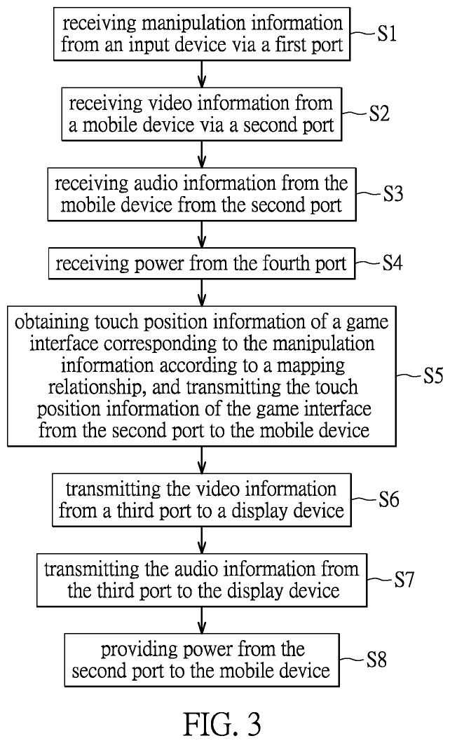

As shown in FIG. 3, the game control method includes the following steps, wherein the step number is only used to distinguish the steps, and does not indicate the sequence relationship.

Step S1: receiving manipulation information from the input device 40 from the first port.

The manipulation information is generated by the input device 40, and different manipulation information can be generated by pressing different keys of the keyboard. The manipulation information is preferably composed of a plurality of bytes, one of the plurality of bytes is configured to characterize the key value of the function key, and the other of the plurality of bytes are configured to characterize the key values of the letter keys, the arrow keys and/or the number keys.

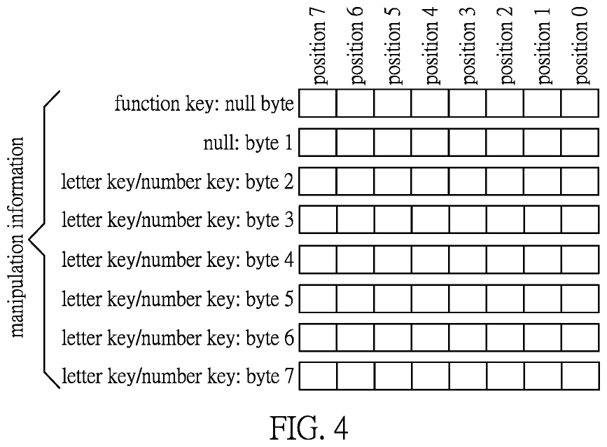

As an implementation manner, the manipulation information consists of eight bytes, as shown in FIG. 4. Among them, byte 0 is configured to characterize the key value of a function key. Function keys include but are not limited to one or more of the left shift key, right shift key, F1-F12 key, left Alt key, right Alt key, left Ctrl key, and right Ctrl key, in which different byte values represent different function keys, and the value of byte 0 can be configured to know which function key is pressed. Byte 1 is a null byte. A total of six bytes, byte 2 to byte 7, are configured to characterize the key values of letter keys, arrow keys and/or number keys. The arrow keys include four arrow keys up, down, left, and right. In this way, the user can press up to seven keys to control the game at the same time. The eight bytes are arranged in order to form manipulation information.

Step S2: receiving video information from the mobile device 10 from the second port, that is, the game screen.

Step S3: receiving audio information from the mobile device 10 from the second port, that is, the voice in the game. Step S3 is an unnecessary step, and the mobile device 10 can be configured to play the game voice.

Step S4: receiving a power from power supply equipment from the fourth port. Step S4 is also an unnecessary step.

Step S5: obtaining touch position information of a game interface corresponding to the manipulation information according to a mapping relationship, and transmitting the touch position information of the game interface from the second port to the mobile device 10.

The mapping relationship here refers to the corresponding relationship between the manipulation information and the touch position information of the game interface. Examples are as follows.

If the game interface has four touch positions A, B, C, and D, their position information is expressed as [x1, y1], [x2, y2], [x3, y3], [x4, y4].

The definition is as follows. Touch position A is controlled by Alt key+A key, touch position B is controlled by Alt key+B key, touch position C is controlled by Alt key+C key, and touch position D is controlled by Alt key+D key.

If the manipulation information generated when the Alt key+A key is pressed is 00000 . . . 0001, the manipulation information generated when the Alt key+B key is pressed is 00000 . . . 0010, and if the manipulation information generated when the Alt key+C key is pressed is 00000 . . . 0011, the manipulation information generated when pressing the Alt key+D key is 00000 . . . 0100.

The mapping relationship is as follows.
[x1, y1] - - - 00000 . . . 0001
[x2, y2] - - - 00000 . . . 0010
[x3, y3] - - - 00000 . . . 0011
[x4, y4] - - - 00000 . . . 0100

The mapping relationship is pre-stored in the memory of the docking station 20, and every time there is a new game, the mapping relationship of the new game is stored in the memory of the docking station 20.

According to the above mapping relationship, the touch position information of the game interface corresponding to the manipulation information can be found, and the touch position information can be transmitted from the second port to the mobile device 10, thereby controlling the mobile device 10 to execute the game operation when the touch position is touched.

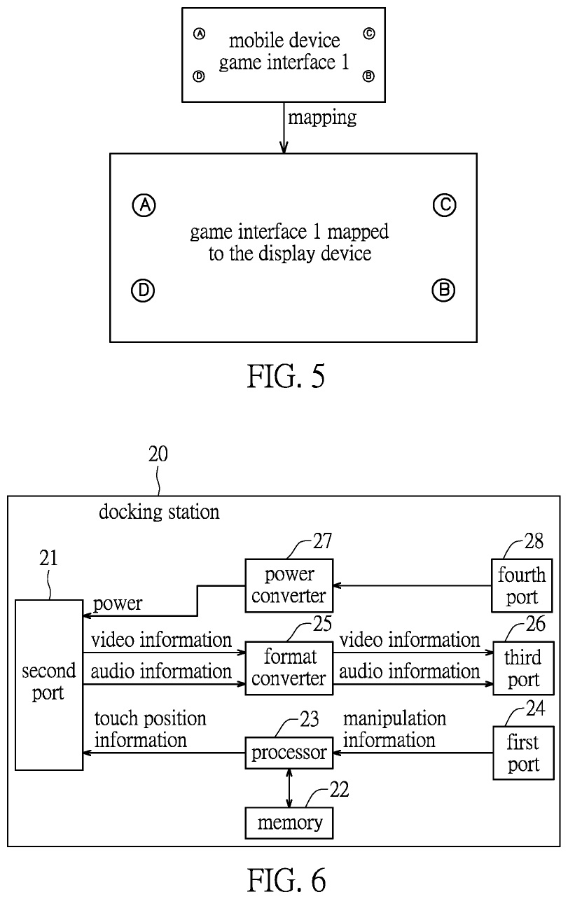

Step S6: transmitting the video information from the third port to the display device 30, so that the game screen is mapped on the display device 30 to embody a large-screen display, as shown in FIG. 5.

Step S7: transmitting the audio information from the third port to the display device 30, and playing the voice in the game through the speaker built in the display device 30. The step S7 is also not a necessary step.

Step S8: providing the power from the second port to the mobile device 10. In this way, there is no need to pause the game to charge the mobile device 10, which solves the problem that the mobile device 10 cannot be charged after the display device 30 and the input device 40 are connected externally because the mobile device 10 has only one port. The step S8 is also not a necessary step.

Further, when the third port is a specific port, the game control method further includes the step of performing a format conversion on the video information before the video information is transmitted from the third port to the display device 30. For example, in an embodiment, the third port is an HDMI (High Definition Multimedia Interface, high-definition multimedia interface) port, the second port is a TYPE-C port. Before the video information is transmitted from the third port to the display device 30, the video information in DP (DisplayPort) format is converted into video information in HDMI format.

### Second Embodiment: Docking Station

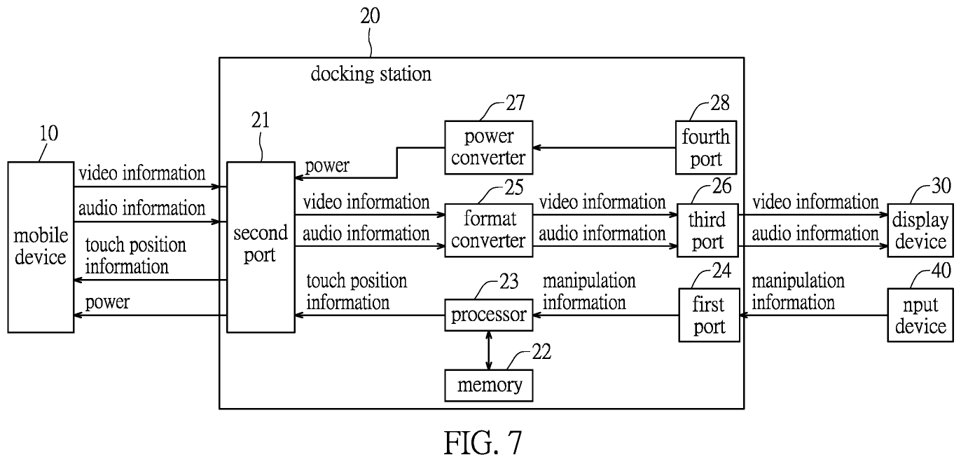

FIG. 6 schematically shows a circuit block diagram of the docking station 20, and FIG. 7 schematically shows a game control system formed by the docking station.

Referring to FIGS. 6 and 7, the docking station 20 includes: a first port 24 for connecting an input device 40, a second port 21 for connecting a mobile device 10, a third port 26 for connecting a display device 30, a memory 22, a processor 23, and a computer program stored in the memory 22 and capable of running on the processor 23. When the processor 23 runs the computer program, the docking station 20 executes the game control method mentioned in the first embodiment.

The docking station 20 can be connected to the mobile device 10, the display device 30, and the input device 40, and serves as a medium for the mobile device 10, the display device 30, and the input device 40. Using the docking station 20 as a medium, the external input device 40 can be configured to control the game of the mobile device 10 while the game screen can be enlarged and displayed on the display device 30, which effectively solves the problem of small display interface and inconvenient control of mobile devices 10 such as smart phones and tablets.

Further, the second port 21 includes a power terminal and a data terminal that can transmit information in both directions. In this way, the mobile device 10 can be powered through the power terminal, the docking station 20 can transmit touch position information to the mobile device 10 through the data terminal, and the mobile device 10 can transmit video information to the docking station 20. The second port 21 that can be used includes, but is not limited to, a USB Type-C port.

Furthermore, the docking station 20 further includes a format converter 25 connected between the third port 26 and the second port 21. In a preferred embodiment, the second port 21 is a USB Type-C port, the third port 26 is an HDMI port, the format converter 25 converts DP format information received by the second port 21 into HDMI format information, and then the converted information is transmitted to the third port 26.

Further, the docking station 20 further includes: a fourth port 28 configured to be connected to power supply equipment, and a power converter 27 connected between the fourth port 28 and the second port 21. In this way, by means of the connection of the fourth port 28 and the power supply equipment, the power converter 27 can convert the power output from the power supply equipment and transmit the converted power to the mobile device 10 through the second port 21, which can solve the problem that the mobile device 10 cannot continue the game after the battery is exhausted during the game.

### Third Embodiment: Game Control System

As shown in FIG. 7, the game control system includes: a mobile device 10 capable of running games, an input device 40 for controlling the game, a display device 30 for displaying game content, and a docking station 20. The mobile device 10 is connected to the second port 21 of the docking station 20, the input device 40 is connected to the first port 24 of the docking station 20, and the display device 30 is connected to the third port 26 of the docking station 20. The corresponding keys are operated on the input device 40 to be converted into the manipulation information and transmitted to the docking station 20, then is converted into the touch position information of the game interface via the docking station 20, and transmitted to the mobile device 10 via the second port 21, thereby controlling the game of the mobile device 10. At the same time, the mobile device 10 transmits the video information to the docking station 20 through the second port 21, and after being converted by the format converter 25 in the docking station 20, the converted video information is transmitted from the third port 26 to the display device 30, and the game screen is displayed on the display device 30.

Power supply equipment can also be connected to the fourth port 28 of the docking station 20, and the power converter 27 in the docking station 20 converts the power output from the power supply equipment and supplies power to the mobile device 10 through the second port 21.

The optional mobile device 10 includes, but is not limited to, a smart phone, a tablet computer, or a handheld game console. The optional input device 40 includes, but is not limited to, a keyboard and a mouse. The docking station 20 may be any one of the docking station as mentioned in the embodiments.

It can be seen from the above embodiments that the present disclosure uses a special docking station as a medium to control mobile device games, which not only embodies the display of game content on large-screen display devices, but also achieves the use of external keyboard and mouse input devices to control mobile device games. Therefore, the present disclosure effectively solves the problem that the existing mobile games have a small display interface and the inability to control the game with the keyboard. In particular, the present disclosure solves the problem that the existing mobile devices such as smart phones cannot be connected to the display device and input devices such as a keyboard and a mouse at the same time, and the problem of small display interface and inconvenient control of the mobile game.

The present disclosure has been described in detail through specific embodiments above. These detailed descriptions are only limited to helping those skilled in the art understand the content of the present disclosure, and should not be understood as limiting the protection scope of the present disclosure. Various modifications, equivalent transformations, etc., performed by those skilled in the art on the above solutions under the concept of the present disclosure should be included in the protection scope of the present disclosure.

What is claimed is:

1. A game control method, comprising the following steps:
receiving manipulation information from an input device via a first port;
receiving video information from a mobile device via a second port;
obtaining touch position information of a game interface corresponding to the manipulation information according to a mapping relationship, and transmitting the touch position information of the game interface from the second port to the mobile device; and
transmitting the video information from a third port to a display device.

2. The game control method according to claim 1, further comprising:
receiving audio information from the mobile device via the second port; and
transmitting the audio information from the third port to the display device;
wherein, the display device includes a speaker.

3. The game control method according to claim 1, further comprising:
receiving a power via a fourth port; and
providing the power from the second port to the mobile device.

4. The game control method according to claim 1, further comprising: performing a format conversion on the video information before the video information is transmitted from the third port to the display device.

5. The game control method according to claim 1, wherein the manipulation information comprises a plurality of bytes, wherein one of the plurality of bytes is configured to characterize a key value of a function key, and the other of the plurality of bytes are configured to characterize key values of letter keys, arrow keys and/or number keys.

6. A docking station, comprising:
a first port configured to connect an input device;
a second port configured to connect to a mobile device;
a third port configured to connect to a display device;
a memory;
a processor; and
a computer program stored in the memory and capable of running on the processor, and wherein when the processor runs the computer program, the docking station executes the game control method according to claim 1.

7. The docking station according to claim 6, wherein the second port comprises a power terminal and a data terminal configured to transmit information bidirectionally.

8. The docking station according to claim 7, wherein the second port is a USB TYPE-C port.

9. The docking station according to claim 6, wherein the docking station further comprises a format converter connected between the third port and the second port.

10. The docking station according to claim 6, further comprising:
a fourth port configured to connect to power supply equipment; and
a power converter connected between the fourth port and the second port.

11. A game control system, comprising:
a mobile device capable of running games;
an input device configured to control games;
a display device configured to display game content; and
a docking station respectively connected to the mobile device, the input device and the display device, and wherein the docking station is the docking station according to claim 6.

12. The game control system according to claim 11, wherein the input device comprises a keyboard and the mobile device comprises a smart phone, a tablet computer, or a handheld game console.

13. The game control system according to claim 11, wherein the second port of the docking station comprises a power terminal and a data terminal capable of transmitting information bidirectionally.

14. The game control system according to claim 13, wherein the second port is a USB TYPE-C port.

15. The game control system according to claim 11, wherein the docking station further comprises a format converter connected between the third port and the second port.

16. The game control system according to claim 11, wherein the docking station further comprises:
a fourth port configured to be connected to power supply equipment; and
a power converter connected between the fourth port and the second port.
